(19) United States
(12) Patent Application Publication
(10) Pub. No.: US 2006/0217522 A1
(43) Pub. Date: Sep. 28, 2006

(54) Method for the production of polyamides

(75) Inventors: Jürgen Demeter, Ludwigshafen (DE); Oliver Sötje, Mannheim (DE); Hans-Jürgen Bassler, Ekeren (DE); Jürgen Deininger, Oftersheim (DE); Karl-Heinrich Klappert, Birkenheide (DE); Helmut Winterling, Ludwigshafen (DE)

Correspondence Address: CONNOLLY BOVE LODGE & HUTZ LLP, SUITE 800, 1990 M STREET NW, WASHINGTON, DC, 20036-3425, US

(73) Assignee: BASF Aktiengesellscaft Patents, Trademarks and Licenses, Ludwigshafen (DE)

(21) Appl. No.: 10/568,810

(22) PCT Filed: Jul. 15, 2004
(86) PCT No.: PCT/EP04/07874

§ 371 Date: Feb. 21, 2006

(30) Foreign Application Priority Data
Aug. 20, 2003 (DE) 103 38 919.9

(51) Int. Cl. C08G 73/10

(52) U.S. Cl. 528/312; 564/152; 422/131

(57) ABSTRACT

An apparatus for making polyamides oligomers thereof mixtures thereof, the apparatus comprising a material selected from the group consisting of a) an austenitic steel comprising from 15 to 25% by weight of chromium, from 3 to 35% by weight of nickel and from 0 to 10% by weight of molybdenum, and iron, b) a duplex steel comprising from 20 to 30% by weight of chromium, from 3 to 10% by weight of nickel and from 0 to 5% by weight of molybdenum, and iron, and c) a nickel-based alloy comprising from 12 to 25% by weight of chromium and from 12 to 20% by weight of molybdenum, and nickel

The present invention relates to a process for the preparation of polyamides, oligomers thereof or mixtures thereof, if desired with further reaction products, by reacting a reaction mixture comprising monomers containing —CN groups or —CONH₂ groups and, if desired, further polyamide-forming monomers and/or oligomers and water in an apparatus, wherein the areas of the apparatus which are in contact with the reaction mixture partly or completely comprise a material selected from the group consisting of

a) an austenitic steel comprising, based in each case on a),

from 15 to 25% by weight of chromium,

from 3 to 35% by weight of nickel and

from 0 to 10% by weight of molybdenum,

if desired further alloy components,

the remainder to 100% by weight being iron,

b) a duplex steel comprising, based in each case on b),

from 20 to 30% by weight of chromium,

from 3 to 10% by weight of nickel and

from 0 to 5% by weight of molybdenum,

if desired further alloy components,

the remainder to 100% by weight being iron,

and

c) a nickel-based alloy comprising, based in each case on c),

from 12 to 25% by weight of chromium and

from 12 to 20% by weight of molybdenum,

if desired further alloy components,

the remainder to 100% by weight being nickel.

It furthermore relates to apparatuses which are used in such a process or are intended for such a process.

Processes for the preparation of polyamides, oligomers thereof or mixtures thereof, if desired with further reaction products, by reacting a reaction mixture comprising monomers containing —CN groups, in particular aminonitriles or dinitriles and diamines or a mixture comprising aminonitriles, dinitriles and diamines, or monomers containing —CONH₂ groups, in particular aminocarboxamides or dicarboxamides and diamines or a mixture comprising aminocarboxamide, dicarboxamide and diamine, and, if desired, further polyamide-forming monomers and/or oligomers and water, in particular continuous processes of this type, are known.

Thus, WO 99/43732 describes the procedure for such processes, in particular continuous ones, in a reactive distillation apparatus, heat being introduced into the lower part of the reactive distillation apparatus. The reaction products are removed from the reactive distillation apparatus at the bottom, while ammonia formed in the reaction, any further low molecular weight compounds formed and water are removed via the top. Tray columns, bubble columns or dividing wall columns are mentioned as possible reactive distillation columns.

U.S. Pat. No. 6,201,096 describes the procedure for such a process, in particular a continuous one, in a reactive distillation apparatus, steam being introduced into the lower part of the reactive distillation apparatus. The high molecular weight compounds obtained as a product are removed from the reactive distillation apparatus at the bottom. Tray columns, such as those having trays made of perforated metal sheet, are mentioned as possible reactive distillation columns. According to U.S. Pat. No. 6,437,089, a mixture of 6-aminocapronitrile and caprolactam can be used as starting monomers in the process described in U.S. Pat. No. 6,201,096.

German Application 10313681.9 describes a process for the preparation of polyamides, oligomers thereof or mixtures thereof, if desired with further reaction products, by reacting a reaction mixture comprising monomers containing —CN groups and, if desired, further polyamide-forming monomers and/or oligomers and water in a reactor, having a vertically oriented longitudinal axis, in which, in the reactor, the reaction product is discharged from the bottom and ammonia formed and any further low molecular weight compounds formed and water are taken off via the top, the reactor having at least two chambers arranged one on top of another in the longitudinal direction and separated from one another by liquid-tight trays, each chamber being connected by a liquid overflow to the chamber directly underneath, and a liquid product stream being taken off via the liquid overflow of the lowermost chamber, the gas space above the liquid level in each chamber being connected to the respective chamber arranged directly above by one or more conveying pipes which in each case open into a gas distributor having orifices for the gas exit below the liquid level, and having at least one metal deflecting plate which is arranged vertically around each gas distributor and whose upper end ends below the liquid level and whose lower end ends above the liquid-tight tray of the chamber and each chamber being separated into one or more gassed and into one or more ungassed spaces.

German Application 10313682.7 describes a process for the preparation of polyamides, oligomers thereof or mixtures thereof, if desired with further reaction products, by reacting a reaction mixture comprising monomers containing —CN groups and, if desired, further polyamide-forming monomers and/or oligomers and water in a kettle cascade.

In these processes, it is desirable to obtain a product of high purity. Product intended for use as a spinning polymer should have no discolorations, since otherwise the production of white yarns or fabrics is virtually impossible and establishing specific colors by adding dyes or pigments is made more difficult.

If such products are used for the production of films, said products should have no discolorations, since otherwise the production of colorless, transparent films is made more difficult or is even impossible.

Product intended for the production of moldings should have no discolorations, since otherwise the production of white molding is virtually impossible and establishing specific colors by adding dyes or pigments is made more difficult.

Furthermore, the process should permit the preparation of such polyamides in a technically simple and economical manner.

Accordingly, the process defined at the outset was found.

According to the invention, monomers containing —CN groups or —CONH₂ groups are used.

Aminonitriles or dinitriles are preferred as monomers containing —CN groups.

It is in principle possible to use all aminonitriles, i.e. compounds which have both at least one amino group and at least one nitrile group. Among these, ω-aminonitriles are preferred, among the latter particularly w-aminoalkylnitriles having 4 to 12, more preferably 4 to 9, carbon atoms in the alkylene radical, or an aminoalkylarylnitrile of 8 to 13 carbon atoms, being used, those which have an alkyl spacer of at least one carbon atom between the aromatic unit and the amino group and nitrile group being preferred here. Particularly preferred aminoalkylarylnitriles are those which have the amino and nitrile group in the 1,4-position relative to one another.

Linear ω-aminoalkylnitriles are more preferably used as the ω-aminoalkylnitrile, the alkylene radical (—CH₂—) containing preferably 4 to 12, more preferably 4 to 9, carbon atoms, such as 6-amino-1-cyanopentane (6-aminocapronitrile), 7-amino-1-cyanohexane, 8-amino-1-cyanoheptane, 9-amino-1-cyanooctane or 10-amino-1-cyanononane, particularly preferably 6-aminocapronitrile.

6-Aminocapronitrile is usually obtained by hydrogenation of adiponitrile by known processes, for example described in DE-A 836, 938, DE-A 848, 654 or U.S. Pat. No. 5,151,543.

Of course, mixtures of a plurality of aminonitriles or mixtures of an aminonitrile with further comonomers, for example caprolactam, or the mixture defined in more detail below, can also be used.

In principle, it is possible to use all dinitriles, i.e. compounds which have at least two nitrile groups. Among these, α,ω-dinitriles are preferred, among the latter particularly α,ω-dinitriles having 4 to 12, more preferably 4 to 9, carbon atoms in the alkylene radical, or a cyanoalkylarylnitrile of 7 to 12 carbon atoms, being used, those which have an alkyl spacer of at least one carbon atom between the aromatic unit and the two nitrile groups being preferred here. Among the cyanoalkylarylnitriles, those which have the two nitrile groups in the 1,4-position relative to one another are particularly preferred.

Linear α,ω-alkylenedinitriles are more preferably used as the α,ω-alkylenedinitrile, the alkylene radical (—CH₂—) preferably containing 3 to 11, more preferably 3 to 8, carbon atoms, such as 1,4-dicyanobutane (adiponitrile), 1,5-dicyanopentane, 1,6-dicyanohexane, 1,7-dicyanoheptane, 1,8-dicyanooctane, 1,9-dicyanononane or 1,10-dicyanodecane, particularly preferably adiponitrile.

For the preparation of polyamides, dinitriles and diamines can be reacted with one another.

In principle, all diamines, i.e. compounds which have at least two amino groups, can be used. Among these, α,ω-diamines are preferred, among the latter particularly α,ω-diamines having 4 to 14, more preferably 4 to 10, carbon atoms in the alkylene radical, or an aminoalkylarylamine of 7 to 12 carbon atoms, being used, those which have an alkyl spacer of at least one carbon atom between the aromatic unit and the two nitrile groups being preferred here. Particularly preferred aminoalkylarylamines are those which have the two amino groups in the 1,4-position relative to one another.

Linear α,ω-alkylenediamines are more preferably used as the α,ω-alkylenediamine, the alkylene radical (—CH₂—) preferably containing 3 to 12, more preferably 3 to 8, carbon atoms, such as 1,4-diaminobutane, 1,5-diaminopentane, 1,6-diaminohexane (hexamethylenediamine), 1,7-diaminoheptane, 1,8-diaminooctane, 1,9-diaminononane or 1,10-diaminodecane, particularly preferably hexamethylenediamine.

If desired, diamines, dinitriles and aminonitriles which are derived from branched alkylenes or arylenes or alkylarylenes may also be used, such as 2-methylglutaronitrile or 2-methyl-1,5-diaminopentane.

If dinitriles and diamines or a mixture comprising dinitrile, diamine and aminonitrile are or is used in the novel preparation of polyamides, a molar ratio of the nitrile groups present in the starting materials and capable of polyamide formation to the amino groups present in the starting materials and capable of polyamide formation of from 0.9 to 1.1, preferably from 0.95 to 1.05, in particular from 0.99 to 1.01, particularly preferably of 1, has proven advantageous.

Preferred monomers containing —CONH₂ groups are aminocarboxamides and dicarboxamides.

In principle, it is possible to use all aminocarboxamides, i.e. compounds which have both at least one amino group and at least one carboxamide group. Among these, ω-aminocarboxamides are preferred, among the latter particularly ω-aminoalkylcarboxamides having 4 to 12, more preferably 4 to 9, carbon atoms in the alkylene radical, or an aminoalkylarylcarboxamide of 8 to 13 carbon atoms, being used, those which have an alkyl spacer of at least one carbon atom between the aromatic unit and the amino group and carboxamide group being preferred here. Among the aminoalkylarylcarboxamides, those which have the amino group and carboxamide group in the 1,4-position relative to one another are particularly preferred.

Linear ω-aminoalkylcarboxamides are more preferably used as the ω-aminoalkylcarboxamide, the alkylene radical (—CH₂—) preferably containing 4 to 12, more preferably 4 to 9, carbon atoms, such as 5-aminopentane-1-carboxamide (6-aminocaproamide), 6-aminohexane-1-carboxamide, 7-aminoheptane-1-carboxamide, 8-aminooctane-1-carboxamide or 9-aminononane-1-carboxamide, particularly preferably 6-aminocaproamide.

6-Aminocaproamide is usually obtained by hydrogenation of adiponitrile by known processes, for example described in DE-A 836, 938, DE-A 848, 654 or U.S. Pat. No. 5,151,543, to give 6-aminocapronitrile and subsequent hydrolysis to give 6-aminocaproamide.

Mixtures of a plurality of aminocarboxamides or mixtures of an aminocarboxamide with further comonomers, for example caprolactam, or the mixture defined in more detail below, can of course also be used.

In principle, it is possible to use all dicarboxamides, i.e. compounds which have at least two carboxamide groups. Among these, α,ω-dicarboxamides are preferred, among the latter particularly α,ω-dicarboxamides having 4 to 12, more preferably 4 to 9, carbon atoms in the alkylene radical, or an (alkylenecarboxamide)-arylcarboxamide of 7 to 12 carbon atoms, being used, those which have an alkyl spacer of at least one carbon atom between the aromatic unit and the two carboxamide groups being preferred here. Among the (alkylenecarboxamide)-arylcarboxamides, those which have the two carboxamide groups in the 1,4-position relative to one another are particularly preferred.

Linear α,ω-alkylenedicarboxamides are more preferably used as the α,ω-alkylenedicarboxamide, the alkylene radical (—CH₂—) preferably containing 3 to 11, more preferably 3 to 8, carbon atoms, such as butane-1,4-dicarboxamide (adipodiamide), pentane-1,5-dicarboxamide, hexane-1,6-dicarboxamide, heptane-1,7-dicarboxamide, octane-1,8-dicarboxamide, nonane-1,9-dicarboxamide or decane-1,10-dicarboxamide, particularly preferably adipodiamide.

For the preparation of polyamides, dicarboxamides and diamines can be reacted with one another.

In principle, it is possible to use all diamines, i.e. compounds which have at least two amino groups. Among these, α,ω-diamines are preferred, among the latter particularly α,ω-diamines having 4 to 14, more preferably 4 to 10, carbon atoms in the alkylene radical, or an aminoalkylarylamine of 7 to 12 carbon atoms, being used, those which have an alkyl spacer of at least one carbon atom between the aromatic unit and the two nitrile groups being preferred here. Among the aminoalkylarylamines, those which have the two amino groups in the 1,4-position relative to one another are particularly preferred.

Linear α,ω-alkylenediamines are more preferably used as the α,ω-alkylenediamine, the alkylene radical (—CH₂—) preferably containing 3 to 12, more preferably 3 to 8, carbon atoms, such as 1,4-diaminobutane, 1,5-diaminopentane, 1,6-diaminohexane (hexamethylenediamine), 1,7-diaminoheptane, 1,8-diaminooctane, 1,9-diaminononane or 1,10-diaminodecane, particularly preferably hexamethylenediamine.

If desired, it is also possible to use diamines, dicarboxamides and aminocarboxamides which are derived from branched alkylenes or arylenes or alkylarylenes, such as 2-methylglutarodiamide or 2-methyl-1,5-diaminopentane.

If dicarboxamides and diamines or a mixture comprising dicarboxamide, diamine and aminocarboxamide are or is used in the novel preparation of polyamides, a molar ratio of the carboxamide groups present in the starting materials and capable of polyamide formation to the amino groups present in the starting materials and capable of polyamide formation of from 0.9 to 1.1, preferably from 0.95 to 1.05, in particular from 0.99 to 1.01, particularly preferably 1, has proven advantageous.

Nitrilocarboxamides are advantageous as monomers which carry both a —CONH₂ group and a —CN group.

In principle, it is possible to use all nitrilocarboxamides, i.e. compounds which have both at least one nitrile group and at least one carboxamide group. Among these, ω-nitrilocarboxamides are preferred, among the latter particularly ω-nitriloalkylcarboxamides having 3 to 12, more preferably 3 to 9, carbon atoms in the alkylene radical, or a nitriloalkylarylcarboxamide of 8 to 13 carbon atoms, being used, those which have an alkyl spacer of at least one carbon atom between the aromatic unit and the nitrile group and carboxamide group being preferred here. Among the nitriloalkylarylcarboxamides, those which have the nitrile group and carboxamide group in the 1,4-position relative to one another are particularly preferred.

Linear ω-nitriloalkylcarboxamides are more preferably used as the ω-nitriloalkylcarboxamide, the alkylene radical (—CH₂—) preferably containing 3 to 12, more preferably 3 to 9, carbon atoms, such as 5-cyanopentane-1-carboxamide (nitriloadipamide), 6-cyanohexane-1-carboxamide, 7-cyanoheptane-1-carboxamide, 8-cyanooctane-1-carboxamide or 9-cyanononane-1-carboxamide, particularly preferably nitriloadipamide.

Nitriloadipamide is usually obtained by partial hydrolysis of adiponitrile.

For the preparation of polyamides, nitrilocarboxamides and diamines can be reacted with one another.

Diamines used can in principle be any diamines, i.e. compounds which have at least two amino groups. Among these, α,ω-diamines are preferred, among the latter in particular α,ω-diamines having 4 to 14, more preferably 4 to 10, carbon atoms in the alkylene radical, or an aminoalkylarylamine of 7 to 12 carbon atoms, being used, and among which in turn those which have an alkyl spacer of at least one carbon atom between the aromatic unit and the two nitrile groups being preferred. Among the aminoalkylarylamines, those which have the two amino groups in the 1,4-position relative to one another are particularly preferred.

Linear α,ω-alkylenediamines are more preferably used as the α,ω-alkylenediamine, the alkylene radical (—CH₂—) preferably containing 3 to 12, more preferably 3 to 8, carbon atoms, such as 1,4-diaminobutane, 1,5-diaminopentane, 1,6-diaminohexane (hexamethylenediamine), 1,7-diaminoheptane, 1,8-diaminooctane, 1,9-diaminononane or 1,10-diaminodecane, particularly preferably hexamethylenediamine.

If desired, it is also possible to use diamines and nitrilocarboxamides which are derived from branched alkylenes, arylenes or alkylarylenes, such as 2-methylglutaronitrilocarboxamide or 2-methyl-1,5-diaminopentane.

If nitrilocarboxamides and diamines are used in the novel preparation of polyamides, a molar ratio of the sum of the carboxamide groups and nitrile groups present in the starting materials and capable of polyamide formation to the amino groups present in the starting materials and capable of polyamide formation of from 0.9 to 1.1, preferably from 0.95 to 1.05, in particular from 0.99 to 1.01, particularly preferably 1, has proven advantageous.

Mixtures comprising one, two, three, four or five of the components selected from the group consisting of dicarboxamides, nitrilocarboxamides, dinitriles, diamines, aminonitriles and aminocarboxamides may also be used in the novel preparation of polyamides. Those mixtures which contain a nitrile and the corresponding aminocarboxamide, such as 6-aminocapronitrile and 5-aminopentane-1-carboxamide, or a dinitrile and the corresponding carboxamide and/or the corresponding nitrilocarboxamide, such as adiponitrile, nitriloadipamide and adipodiamide, with a diamine are advantageously used here.

For example, the dicarboxylic acids, such as alkanedicarboxylic acids of 6 to 12, in particular 6 to 10, carbon atoms, such as adipic acid, pimelic acid, suberic acid, azelaic acid or sebacic acid and terephthalic acid, isophthalic acid and cyclohexanedicarboxylic acid, or amino acids, such as alkaneamino acids of 5 to 12 carbon atoms, in particular α,ω-C₅-C₁₂-amino acids, may be used as further polyamide-forming monomers.

5-Aminopentanoic acid, 6-aminohexanoic acid, 7-aminoheptanoic acid, 8-aminooctanoic acid, 9-aminononanoic acid, 10-aminodecanoic acid, 11-aminoundecanoic acid and 12-aminododecanoic acid, preferably 6-aminohexanoic acid or the internal amides thereof, i.e. lactams, in particular caprolactam, can be used as the α,ω-C₅-C₁₂-amino acid.

Suitable starting materials in the novel process are furthermore mixtures with aminocarboxylic acid compounds of the formula I
R²R³N—(CH₂)ₘ—C(O)R¹ (I)
where R¹ is —OH, —OC₁₋₁₂-alkyl or —NR²R³, R² and R³, independently of one another, are hydrogen, C₁₋₁₂-alkyl or C₅₋₈-cycloalkyl, and m is 3, 4, 5, 6, 7, 8, 9, 10, 11 or 12.

Particularly preferred aminocarboxylic acid compounds are those in which R¹ is OH, —O—C₁₋₄alkyl such as —O-methyl, —O-ethyl, —O-n-propyl, —O-isopropyl, —O-n-butyl, —O-sec-butyl or —O-tert-butyl, or —NR²R³, such as —NH₂, —NHMe, —NHEt, —NMe₂ or —NEt₂, and m is 5.

6-Aminocaproic acid, methyl 6-aminocaproate, ethyl 6-aminocaproate, N-methyl-6-aminocaproamide, N,N-dimethyl-6-aminocaproamide, N-ethyl-6-aminocaproamide and N,N-diethyl-6-aminocaproamide are very particularly preferred.

The starting compounds are commercially available or, for example, can be prepared according to EP-A 0 234 295 and Ind. Eng. Chem. Process Des. Dev. 17 (1978), 9-16.

It is also possible to use any desired mixtures of said compounds, aminocarboxylic acid compounds, lactams, diamines and dioic acids or salts thereof.

Aminonitriles or dinitriles and diamines or mixtures comprising aminonitrile, dinitrile and diamine, together with water, particularly preferably in a molar ratio of from 1:1 to 1:20, based on the total process, are preferably used as polyamide-forming monomers. Aminocapronitrile at a molar ACN:water ratio of from 1:1 to 1:6 in the total process is particularly preferred. A mixture of adiponitrile and hexamethylenediamine, at a molar ratio of the sum of adiponitrile and hexamethylenediamine to water of from 1:1 to 1:6 in the total process is furthermore particularly preferred. A mixture of adiponitrile, hexamethylenediamine and aminocapronitrile, at a molar ratio of the sum of adiponitrile, hexamethylenediamine and aminocapronitrile to water of from 1:1 to 1:6 in the total process is furthermore particularly preferred.

Mixtures of polyamide-forming monomers and oligomers may also be used.

In addition to aminocapronitrile, if desired caprolactam and/or hexamethylenediammonium adipate (AH salt) are preferably used as polyamide-forming monomers.

In addition to adiponitrile and hexamethylenediamine, if desired caprolactam and/or hexamethylenediammonium adipate (AH salt) are preferably used as polyamide-forming monomers.

According to the invention, the monomers carrying —CN groups or CONH₂ groups are reacted in the presence of water.

The water can be partly or completely added to the monomers before the reaction mixture is fed into the reactor for carrying out the novel process.

Furthermore, the water can be partly or completely fed to the reactor at a point other than that at which the monomers are fed in.

Regarding the monomers to be reacted, the water can advantageously be fed in in stoichiometric amounts.

The water may be present in a superstoichiometric concentration in the reactor even when the water is metered in in a stoichiometric amount (molar ratio of high boilers to water from about 1:4 to 1:50, preferably from 1:10 to 1:40), which may shift the equilibrium of the reaction to the product side and may increase the rate at which equilibrium is established.

The reaction can be carried out in the absence of a catalyst or preferably in the presence of a catalyst.

In addition to acid catalysts, such as phosphoric acid, etc., widely described in the literature, suitable catalysts are in general particularly heterogeneous catalysts. It is preferable to use Brönsted acid catalysts selected from a beta-zeolite, sheet silicate or fixed-bed catalyst, which substantially comprises TiO₂ with from 70 to 100% of anatase and from 0 to 30% of rutile, in which up to 40% of the TiO₂ may be replaced by tungsten oxide.

For example, corresponding TiO₂ modifications which are available from Finnti (type S150) may be used.

The heterogeneous catalysts can be introduced into the apparatus, for example, as a suspension, sintered on dumped packings, or as an uncoated or coated catalyst packing or bed or internals. They may also be present in the apparatus as a coating on the wall or as a bed against the wall, so that separation from the reaction mixture can be easily effected.

Depending on the water concentration, the residence time, the use of catalysts and the starting material composition or concentration, the temperature for the reaction in the reaction part of the reactor should be from about 180 to 300° C., preferably from 200 to 280° C., particularly preferably from 220 to 270° C.

The reaction can be carried out as a one-phase or two-phase reaction. The two-phase procedure permits a reduction of the pressure level required for the reaction, since gaseous components need not be kept in the liquid phase, as in the case of a one-phase procedure. Preferably, only the autogenous pressure of the system is established depending on the temperature. This is from about 10 to 60 bar.

In the case of a one-phase procedure, pressures of from 60 to 120 bar have proven advantageous.

According to the invention, the preparation of the polyamides is carried out in an apparatus. Suitable apparatuses in the context of the present invention are one or more reactors, the pipelines used for conveying the material streams, auxiliary units used for operating the reactor or the reactors, such as heat exchangers, pumps or valves, in particular one or more reactors.

The reactors which can be used for the novel process are known per se.

For example, it is possible to use a flow tube, which may have internals or packings.

In a preferred embodiment, the reactor used may be a reactive distillation apparatus, preferably a tray column, such as one having perforated sheet metal trays, a bubble column or a dividing wall column, as disclosed, for example, in WO 99/43732, U.S. Pat. No. 6,201,096 or U.S. Pat. No. 6,437,089.

The procedure for the preparation of polyamides using the corresponding reaction parameters, reactant feeds, take-off of product and any byproducts, heat supply and heat removal preferred for a reactive distillation apparatus are known per se, for example from said WO 99/43732, U.S. Pat. No. 6,201,096 or U.S. Pat. No. 6,437,089.

These parameters are hereby incorporated by reference in this Application.

Furthermore, a kettle cascade, as described, for example, in German Application 10313682.7, can be used as a reactor.

The procedure for the preparation of polyamides using the corresponding reaction parameters, reactant feeds, take-off of product and any byproducts, heat supply and heat removal preferred for a kettle cascade are known per se, for example from said German Application 10313682.7.

These parameters are hereby incorporated by reference in this Application.

In a particularly preferred embodiment, a suitable procedure is the novel preparation of polyamides in a reactor having a vertically oriented longitudinal axis, in which, in the reactor, the reaction product is discharged from the bottom and ammonia formed and any further low molecular weight compounds formed and water are taken off via the top, the reactor having at least two chambers arranged one on top of another in the longitudinal direction and separated from one another by liquid-tight trays, each chamber being connected by a liquid overflow to the chamber directly underneath, and a liquid product stream being taken off via the liquid overflow of the lowermost chamber, the gas space above the liquid level in each chamber being connected to the respective chamber arranged directly above by one or more conveying pipes which in each case open into a gas distributor having orifices for the gas exit below the liquid level, and having at least one metal deflecting plate which is arranged vertically around each gas distributor and whose upper end ends below the liquid level and whose lower end ends above the liquid-tight tray of the chamber and each chamber being separated into one or more gassed and into one or more ungassed spaces, as described, for example, in German Application 10313681.9.

The procedure for the preparation of polyamides using the corresponding reaction parameters, reactant feeds, take-off of product and any byproducts, heat supply and heat removal preferred for such a reactor are known per se, for example from said German Application 10313681.9.

These parameters are hereby incorporated by reference in this Application.

It is also possible to combine different reactors for carrying out the novel process. For example, the reaction can be divided into a plurality of part-steps, such as two part-steps.

In an advantageous embodiment, monomers containing —CN groups can be used and, in a first stage, can be reacted with water with partial or complete conversion to give a mixture comprising monomers and oligomers containing —CONH₂ groups. A flow tube can advantageously be used for this purpose.

In a second stage, the mixture obtained from the first stage can be reacted to give a polymer. This reaction can advantageously be carried out in a reactive distillation apparatus, particularly preferably in a reactor, as described in German Application 10313681.9.

According to the invention, that area of the reactor which is in contact with the reaction mixture partly or completely comprises a material selected from the group consisting of

a) an austenitic steel comprising, based in each case on a),

from 15 to 25% by weight of chromium,

from 3 to 35% by weight of nickel and

from 0 to 10% by weight of molybdenum,

if desired further alloy components,

the remainder to 100% by weight being iron,

b) a duplex steel comprising, based in each case on b),

from 20 to 30% by weight of chromium,
from 3 to 10% by weight of nickel and
from 0 to 5% by weight of molybdenum,
if desired further alloy components,
the remainder to 100% by weight being iron,
   and
   c) a nickel-based alloy comprising, based in each case on c),
from 12 to 25% by weight of chromium and
from 12 to 20% by weight of molybdenum,
if desired further alloy components,
the remainder to 100% by weight being nickel.

In the context of the present invention, the area in contact with the reaction mixture is understood as meaning those areas which are in contact or may come into contact with the total reaction mixture, as well as those areas which are in contact or may come into contact with a part of the reaction mixture, for example with the gas phase existing above a liquid reaction mixture, where such a gas phase exists.

The total area, or a part of the area, in contact with the reaction mixture may consist of one of said materials.

The area may consist throughout of one of said materials over the total reactor wall thickness, i.e. from the surface facing the reaction mixture to that surface of this area which is opposite this surface. The area may consist of one of said materials over a part of the reactor wall thickness, i.e. from the surface facing the reaction mixture to a surface present inside the reactor wall, and the reactor wall can then be continued with another material toward the side facing away from the reaction mixture.

In a preferred embodiment, a suitable material a) is an austenitic steel comprising, based in each case on a),

from 15 to 25% by weight of chromium,

from 3 to 35% by weight of nickel and

from 0 to 10% by weight of molybdenum,

if desired further alloy components,

the remainder to 100% by weight being iron,

and furthermore

at the same time the maximum nickel content, in % by weight, based on a), being calculated as a function of the chromium content for a chromium content of from 15 to 20% by weight, based on a), according to the equation
Ni[% by weight]≦5.5·Cr[% by weight]−75
and at the same time the minimum nickel content, in % by weight based on a), being calculated as a function of the chromium content for a chromium content of from 17 to 25% by weight, based on a), according to the equation
Ni[% by weight]≧2.5·Cr[% by weight]−42.5.

Particularly preferred materials a) are those which contain, as further alloy components, one or more elements selected from the group consisting of C, N, Cu, Mn, Al and Ti, advantageously together in an amount of from 0.01 to 10% by weight, based on a).

Particularly preferred materials a) are shown in table 1.

In a preferred embodiment, material b) may contain Mo as a further alloy component, advantageously in amounts of from 0.1 to 5% by weight, based on b).

Furthermore, material b) may contain, as a further alloy component, advantageously C or N or C and N. In a particularly preferred embodiment, material b) may additionally contain, as further alloy components, C or N or C and N in an amount of from 0.05 to 0.5% by weight, based on b), as the sum of C and N.

Particularly preferred materials b) are shown in table 2.

Material c) may preferably additionally contain, as further alloy components, one or more elements selected from the group consisting of W, Ti, Al, Ta, Cu, C and N, advantageously together in an amount of from 0.1 to 50% by weight, based on c).

Furthermore, material c) may preferably contain iron as a further alloy component, advantageously in an amount of from 0.1 to 8% by weight, based on c).

Furthermore, material c) may preferably contain silicon as a further alloy component, advantageously in an amount of from 0.01 to 0.2% by weight, based on c).

Particularly preferred materials c) are shown in table 3.

The production of reactors intended for the novel process and reactors used in the novel process can be carried out by methods known per se for such materials.

The desired product obtained has a different molecular weight adjustable in wide ranges and different properties, depending on the residence time in the reactor, the process temperatures, the pressure conditions and further process engineering parameters. If desired, further processing of the product for establishing desired product properties can be carried out after the reaction.

The product can advantageously be subjected to a polycondensation in order to increase the molecular weight. Such a polycondensation can be carried out by processes known per se for the preparation and aftertreatment of polyamides, for example in a completely continuous flow tube (VK tube).

The polyamide obtained can be worked up by methods known per se, as described in detail, for example, in DE-A 43 21 683 (page 3, line 54 to page 4, line 3).

In a preferred embodiment, the content of cyclic dimer in the polyamide 6 obtained according to the invention can be further reduced by extracting the polyamide first with water or an aqueous solution of caprolactam and then with water and/or subjecting it to gas-phase extraction (for example described in EP-A 0 284 968). The low molecular weight components obtained in this aftertreatment, such as caprolactam and linear and cyclic oligomers, can be recycled to the novel process or to the upstream reactor.

The polyamide obtained after the extraction can in general subsequently be dried in a manner known per se.

This can advantageously be effected with the concomitant use of inert gases, such as nitrogen or superheated steam, as a heating medium, for example by the countercurrent method. Here, the desired viscosity, determined in 1% strength by weight solution in 96% strength sulfuric acid at 25° C., can be established by heating at elevated temperatures, preferably at from 150° C. to 190° C.

The novel process provides good product quality, in particular good color numbers, and hence a higher-quality product. In the context of the present invention, the discoloration is defined by the APHA number and the yellowness index. The APHA number is determined in the manner described in the examples as the difference between the extinctions of a polyamide solution in formic acid at 470 nm and 600 nm. The lower the APHA number, the less the discoloration of the polyamide. The yellowness index is a measure of the surface discoloration of the polyamide and is determined according to DIN 5033 in said examples. The less the yellowness index deviates from zero, the less the surface color deviation of the polyamide granules from the barium sulfate white standard.

The examples which follow illustrate the invention.

### EXAMPLES

Determination of the Solution Viscosity

In the examples, the solution viscosity was measured as the relative solution viscosity in 96% strength sulfuric acid according to DIN 51562-1 to -4. Here, 1 g of polymer was weighed in per 100 ml of solution, and the efflux time in an Ubbelohde viscometer was measured against the pure solvent.

Determination of the APHA Number

The standard method for the quantitative determination of the polyamide discoloration is the measurement of the APHA number (Pt—Co, ASTM 1209-54)

a) Determination of the Calibration Factor f:

0.249 g of potassium hexachloroplatinate(IV) and 0.2 g of cobalt(II) chloride hexahydrate were dissolved in 500 ml of distilled water in a 1 000 ml volumetric flask, 20 ml of hydrochloric acid having a density of 1.18 g/cm³ are added and the solution is made up to the mark with distilled water.

The extinction E₀ of this solution is measured in 5 cm cells at a wavelength of 470 nm against distilled water. The calibration factor f is then calculated as f=100/E₀.

b) Preparation of the Polyamide Solution

7 g of polyamide are dissolved in 100 ml of formic acid in a 200 ml conical flask at room temperature in the course of 16 hours. The solution is then centrifuged at 35 000 G.

c) Measurement of the Color Number

The extinction E of the polyamide solution is measured in a 5 cm cell at a wavelength of 470 nm (E₄₇₀) and 600 nm (E₆₀₀) against formic acid.

The APHA number (in Pt—Co units) was then determined as:
APHA number=f·(E₄₇₀−E₆₀₀)
Determination of the Yellowness Index

The yellowness index was determined according to DIN 5033 in the course of determining the color valency for characterizing the natural color of polyamide granules, which color valency consists of three color values and uniquely specifies a color. The reference system is the internationally agreed CIE system. The standard valency system specified in DIN 5033 is equivalent to the CIE system. The color values in the CIE system are denoted by X, Y and Z.

The three-area method of color measurement for determining the body colors is carried out using the ELREPHO filter photometer. The reflectance of the sample is measured using three special filters, the color measuring filters for standard illuminant C (FMX/C, FMY/C and FMZ/C) and the color value is calculated therefrom.

The filter photometer is calibrated to zero using the barium sulfate white standard (FMX/C adjustment value). In each case a double determination of the FMX/C, FMY/C and FMZ/C measurement is carried out and the mean value is calculated therefrom.

The yellowness index is determined computationally from the difference between the FMX/C and FMZ/C measured values.

Preparation of the Polyamides

### Example 1

A prepolymer was prepared from a mixture of 6-aminocapronitrile and water in an average residence time of 1.5 hours and at a superatmospheric pressure of 80 bar and a temperature of 250° C. in a tubular reactor. That area of the reactor and of the apparatuses used which was in contact with the product stream consisted of the material 1.4571 according to table 1.

A continuous stream of caprolactam (12% by weight), water (22% by weight) and NH₃ (0.5% by weight) and the above-described nylon 6 prepolymer as the remainder was introduced into the upper part of a reactor according to the claims characterized in German Application 10313681.9 with 5 stages and one bottom region. That area of the reactor and of the apparatuses used which was in contact with the product stream consisted of the material 1.4571 according to table 1.

This feed stream had a throughput of 37.7 kg/h and a temperature of 235° C.

The pressure in the reactor was regulated and was 28 bar (gage pressure). The bottom temperature was regulated and was 275° C.

The temperature curve of the reactor was adiabatic. The total residence time in the reactor was 1.65 hours, including a residence time of less than 10 minutes in the bottom region.

The 31.4 kg/h nylon 6 product stream discharged from the bottom region and containing 8.9% by weight of water was then subjected to postcondensation in a completely continuous flow tube (VK tube) according to the prior art. In order to remove the oligomers, the polyamide 6 thus obtained was extracted with water according to the prior art and then dried. The solution viscosity, the APHA number and the yellowness index of the dried polyamide were determined.

Solution viscosity: RV=2.41

APHA number: 2

Yellowness index: 2

### Example 2

The procedure was as in example 1, except that the material 1.4571 was replaced by the material 1.4462 according to table 2.

Solution viscosity: RV=2.40

APHA number: 2

Yellowness index: −4

### COMPARATIVE EXAMPLE

The procedure was as in example 1, except that the material 1.4571 was replaced by the ferritic material 1.4521 according to EN 10088-1 or 10088-2.

Solution viscosity: RV=2.41

APHA number: 20

Yellowness index: 25

TABLE 1
Particularly preferred materials a)

| Material number | | | | | | | | |
|---|---|---|---|---|---|---|---|---|
| EN | | | | | | | | |
| 10088-1 | | Conventional | Chemical composition [% by weight, based on total weight] | | | | | |
| 10088-2 | UNS | alloy designation | C max. | N | Cr | Ni | Mo | Others |
| 1.4310 | S30100 | 301 | 0.15 | 0.03 | 16-19 | 6-9.5 | ≦0.8 | — |
| 1.4318 | S30153 | 301LN | 0.03 | 0.15 | 16.5-18.5 | 6-8 | — | — |
| 1.4372 | S20100 | 201 | 0.15 | 0.15 | 16-18 | 3.5-5.5 | — | 6.5Mn |
| 1.4307 | S30403 | 304L | 0.03 | 0.06 | 17.5-19.5 | 8-10 | | — |
| 1.4301 | S30400 | 304 | 0.07 | 0.05 | 17-19.5 | 8-10.5 | — | — |
| 1.4311 | S30453 | 304LN | 0.03 | 0.14 | 17-19.5 | 8.5-11.5 | — | — |
| 1.4541 | S32100 | 321 | 0.08 | 0.01 | 17-19 | 9-12 | — | Ti |
| 1.4305 | S30300 | 303 | 0.10 | 0.06 | 17-19 | 8-10 | — | S |
| 1.4306 | S30403 | 304L | 0.03 | 0.04 | 18-20 | 10-12 | — | — |
| 1.4303 | S30500 | 305 | 0.06 | 0.02 | 17-19 | 11-13 | — | — |
| 1.4567 | S30430 | 18-9-LW | 0.04 | 0.02 | 17-19 | 8.5-10.5 | — | 3-4Cu |
| 1.4404 | S31603 | 316L | 0.03 | 0.04 | 16.5-18.5 | 10-13 | 2-2.5 | — |
| 1.4401 | S31600 | 316 | 0.07 | 0.04 | 16.5-18.5 | 10-13 | 2-2.5 | — |
| 1.4406 | S31653 | 316LN | 0.03 | 0.14 | 16.5-18.5 | 10-12 | 2-2.5 | — |
| 1.4571 | S31635 | 316Ti | 0.08 | 0.01 | 16.5-18.5 | 10.5-13.5 | 2-2.5 | Ti |
| 1.4432 | S31603 | 316L | 0.03 | 0.05 | 16.5-18.5 | 10.5-13 | 2.5-3 | — |
| 1.4436 | S31600 | 316 | 0.05 | 0.05 | 16.5-18.5 | 10.5-13 | 2.5-3 | — |
| 1.4435 | S31603 | 316L | 0.03 | 0.06 | 17-19 | 12.5-15 | 2.5-3 | — |
| 1.4429 | S31653 | 316LN | 0.03 | 0.14 | 16.5-18.5 | 11-14 | 2.5-3 | — |
| 1.4438 | S31703 | 317L | 0.03 | 0.07 | 17.5-19.5 | 13-16 | 3-4 | — |
| 1.4439 | S31726 | 317LMN | 0.03 | 0.14 | 16.5-18.5 | 12.5-14.5 | 4-5 | — |
| 1.4529 | N08926 | 926 | 0.02 | 0.2 | 19-21 | 24-26 | 6-7 | 1.5Cu |
| 1.4539 | N08904 | 904L | 0.02 | 0.1 | 19-21 | 24-26 | 4-5 | 1.5Cu |
| 1.4547 | S31254 | 254 SMO | 0.02 | 0.20 | 19.5-20.5 | 17.5-18.5 | 6-7 | 1Cu |
| 1.4558 | N08800 | 800L | 0.03 | | 20-23 | 32-35 | | Al, Ti |
| 1.4652 | S32654 | 654 SMO | 0.02 | 0.50 | 23-25 | 21-23 | 7-8 | 3.5Mn, Cu 1 |

TABLE 2
Particularly preferred materials b)

| Material number | | | | | | | | |
|---|---|---|---|---|---|---|---|---|
| EN | | | Chemical composition | | | | | |
| 10088-1 | | Conventional | [% by weight, based on total weight] | | | | | |
| 10088-2 | UNS | alloy designation | C max. | N | Cr | Ni | Mo | Others |
| 1.4362 | S32304 | SAF 2304 | 0.03 | 0.10 | 22-24 | 3.5-5.5 | 0.1-0.6 | — |
| 1.4460 | S32906 | | 0.05 | 0.09 | 25-28 | 4.5-6.5 | 1.3-2 | — |
| 1.4462 | S32205 | 2205 | 0.03 | 0.17 | 21-23 | 4.5-6.5 | 2.5-3.5 | — |
| 1.4410 | S32750 | SAF 2507 | 0.03 | 0.27 | 24-26 | 6-8 | 3-4.5 | — |

TABLE 3
Particularly preferred materials c)

| | DIN | DIN | | | | | | | |
|---|---|---|---|---|---|---|---|---|---|
| Trade name | mat. no. | designation | UNS | Cr | Mo | Other | Ni (max.) | Fe (max.) | Si (max.) |
| Alloy C-276 | 2.4610 | NiMo16Cr15W | N10276 | 14.5-16.5 | 15-17 | W: 3-4.5 | Remainder | 4-7 | 0.08 |
| Alloy C-4 | 2.4819 | NiMo16Cr16Ti | N06455 | 14-18 | 14-17 | Ti: 0.2 | Remainder | 3.0 | 0.08 |
| Alloy C-22 | 2.4602 | NiCr21Mo14W | N06022 | 20-22.5 | 12.5-14.5 | W: 2.5-3.5 | Remainder | 6.0 | 0.08 |
| Alloy 59 | 2.4605 | NiCr21Mo16Al | N06059 | 22-24 | 15-16.5 | Al: 0.1-0.4 | Remainder | 1.5 | 0.1 |
| Inconel 686 | 2.4606 | NiCr21Mo16W | N06686 | 19-23 | 15-17 | W: 3.0-4.4 | Remainder | 2.0 | 0.08 |
| MAT 21 | — | — | N06210 | 18-20 | 18-20 | Ta: 1.5-2.2 | Remainder | 1.0 | 0.08 |
| Hastelloy C-2000 | 2.4675 | NiCr23Mo16Cu | N06200 | 22-24 | 15-17 | Cu: 1.3-1.9 | Remainder | 3.0 | 0.08 |

1. A process for the preparation of polyamides, oligomers thereof or mixtures thereof, by reacting a reaction mixture comprising monomers containing —CN groups or —CONH₂ groups in an apparatus, wherein the areas of the apparatus which are in contact with the reaction mixture comprise a material selected from the group consisting of
a) an austenitic steel comprising,
from 15 to 25% by weight of chromium,
from 3 to 35% by weight of nickel and
from 0 to 10% by weight of molybdenum,
and
iron,
b) a duplex steel comprising,
from 20 to 30% by weight of chromium,
from 3 to 10% by weight of nickel and
from 0 to 5% by weight of molybdenum,
and
iron,
and
c) a nickel-based alloy comprising,
from 12 to 25% by weight of chromium and
from 12 to 20% by weight of molybdenum,
and
nickel.

2. A process as claimed in claim 1, wherein the apparatus material in contact with the reaction mixture is the austenitic steel,
with a maximum nickel content calculated as a function of the chromium content for a chromium content in the range from 15 to 20% by weight according to the equation
Ni[% by weight]≦5.5·Cr[% by weight]-75
or with a minimum nickel content calculated as a function of the chromium content for a chromium content in the range from 17 to 25% by weight according to the equation
Ni[% by weight]≧2.5·Cr[% by weight]−42.5.

3. A process as claimed in claim 1, wherein the apparatus material is the austenitic steel and further comprises one or more alloy elements selected from the group consisting of C, N, Cu, Mn, Al and Ti.

4. A process as claimed in claim 3, wherein the one or more alloy elements are present in an amount of from 0.01 to 10% by weight.

5. A process as claimed in claim 1, wherein the apparatus material is the duplex steel containing from 0.1 to 5% by weight, of molybdenum.

6. A process as claimed in claim 5, wherein the duplex steel further comprises one or more alloy elements selected from C or N or C and N.

7. A process as claimed in claim 6, wherein the one or more alloy elements are present in an amount of from 0.05 to 0.5% by weight as the sum of C and N.

8. A process as claimed in claim 1, wherein the apparatus material is the nickel-based alloy with one or more alloy elements selected from the group consisting of W, Ti, Al, Ta, Cu, C and N.

9. A process as claimed in claim 8, wherein the one or more alloy elements are present in an amount of from 0.1 to 5% by weight.

10. A process as claimed in claim 8, wherein the nickel-based alloy further comprises iron.

11. A process as claimed in claim 10, wherein the iron is present from 0.1 to 8% by weight.

12. A process as claimed in claim 8, wherein the nickel-based alloy further comprises silicon.

13. A process as claimed in claim 12, wherein the silicon is present from 0.01 to 0.2% by weight.

14. An apparatus used in a process for the preparation of polyamides, oligomers thereof or mixtures thereof, by reacting a reaction mixture comprising monomers containing —CN groups or —CONH₂ groups wherein the areas of the apparatus which are in contact with the reaction mixture comprise a material as claimed in claim 1.

15. An apparatus intended for a process for the preparation of polyamides, oligomers thereof or mixtures thereof by reacting a reaction mixture comprising monomers containing —CN groups or —CONH₂, wherein the areas of the apparatus which are to come into contact with the reaction mixture partly or completely comprise a material as claimed in claim 1.

16. A process as claimed in claim 2, wherein the apparatus material is the austenitic steel and further comprises one or more alloy elements selected from the group consisting of C, N, Cu, Mn, Al and Ti.

17. An apparatus for the preparation of polyamides, oligomers thereof or mixtures thereof, wherein areas of the apparatus which are in contact with the reaction mixture comprising monomers containing —CN groups or —CONH₂ groups comprise a material selected from the group consisting of
a) an austenitic steel comprising from 15 to 25% by weight of chromium, from 3 to 35% by weight of nickel, from 0 to 10% by weight of molybdenum and iron,
b) a duplex steel comprising from 20 to 30% by weight of chromium, from 3 to 10% by weight of nickel, from 0 to 5% by weight of molybdenum and iron, and
c) a nickel-based alloy comprising from 12 to 25% by weight of chromium, from 12 to 20% by weight of molybdenum and nickel.

18. An apparatus as claimed in claim 17, wherein the areas of the apparatus in contact with the reaction mixture is the austenitic steel with a maximum nickel content calculated as a function of the chromium content for a chromium content in the range from 15 to 20% by weight according to the equation
Ni[% by weight]≦5.5·Cr[% by weight]−75,
or with a minimum nickel content calculated as a function of the chromium content for a chromium content in the range from 17 to 25% by weight according to the equation
Ni[% by weight]≧2.5·Cr[% by weight]−42.5.

19. An apparatus as claimed in claim 17, wherein the areas of the apparatus in contact with the reaction mixture is the duplex steel containing from 0.1 to 5% by weight of molybdenum.

20. An apparatus as claimed in claim 17, wherein areas of the apparatus in contact with the reaction mixture is the nickel-based alloy with one or more alloy elements selected from the group consisting of W, Ti, Al, Ta, Cu, C and N, and which are present in an amount of from 0.1 to 5% by weight.
